(19) United States
(12) Patent Application Publication
(10) Pub. No.: US 2026/0232409 A1
(43) Pub. Date: Aug. 13, 2026

(54) DENTAL ABUTMENT, METHOD FOR ARRANGING A SUPERSTRUCTURE THEREON, METHOD FOR MANUFACTURE THEREOF AND METHOD FOR IMPLANTATION THEREOF

(71) Applicant: BONECARE DYNAMICS NV, Zonhoven (BE)

(72) Inventor: Gert Roza P. MULLENS, Lummen (BE)

(73) Assignee: BONECARE DYNAMICS NV, Zonhoven (BE)

(21) Appl. No.: 19/154,896

(22) PCT Filed: Feb. 28, 2024
(86) PCT No.: PCT/IB2024/051899

§ 371 Date: Aug. 8, 2025

(30) Foreign Application Priority Data
Feb. 28, 2023 (BE) 2023/5148

(51) Int. Cl. A61C 8/00; A61C 13/00

(52) U.S. Cl. CPC A61C 8/0065; A61C 8/0074; A61C 8/0086; A61C 13/0006

(57) ABSTRACT

The invention relates to a dental abutment for holding a superstructure, such as a prosthetic tooth, comprising a lower part and an upper part, which are mutually connected and are displaceable relative to each other in a direction away from each other and toward each other, wherein the lower part comprises an anchor for anchoring the abutment in the jaw and the upper part comprises a holder for fastening the superstructure thereon. According to the invention, the holder has a screw thread. The invention also relates to a method for manufacturing and for assembling an abutment, and for arranging a superstructure on an abutment.

The invention relates to a dental abutment for holding a superstructure, such as a prosthetic tooth, comprising a lower part and an upper part, which are mutually connected and are displaceable relative to each other in a direction away from each other and toward each other, wherein the lower part comprises an anchor for anchoring the abutment in the jaw and the upper part comprises a holder for fastening the superstructure thereon.

A dental prosthesis is per se known, for instance from US 2007/0259311A1. US 2007/0259311 A1 shows a two-part implant for carrying a dental prosthesis. A lower part is used for anchoring in an implant in the jaw, while the upper part facilitates fastening of the dental prosthesis. Although the two parts are connected to each other, the connection allows for some play so that the two parts are able to move relative to each other. A spring urges the parts apart, resulting in a shock-absorbing construction. The shock-absorbing characteristic is also caused by, in addition to the spring, the use of an elastic material between the two parts.

For placing of the dental prosthesis it is usual, as is also the case in US 2007/0259311A1, to fasten the dental prosthesis onto the upper part of the abutment by means of a clamping (form) fit using a dental cement. Although this known manner of fitting is per se workable, this method has several drawbacks.

Firstly, the use of cement for fitting the prosthetic is risky. This is because any cement residues that may remain behind will have an adverse effect on the surrounding bone, which will recede rapidly. This may result in loss of the abutment, and is therefore known as the main cause of peri-implantitis. It has moreover been found difficult to remove cement residues in the event of incorrect cementing, since they are not even always visible with x-ray technology. It must further be noted that the prostheses attached according to the known method cannot be removed or cannot be removed easily, which may however be necessary in some situations. In this context it is noted that damage to the abutment often occurs when prostheses attached with cement are removed.

The invention therefore has for its object to at least partially obviate the above stated drawbacks.

This object is achieved with a dental abutment of the type stated in the preamble, wherein the holder has a screw thread.

The superstructure can be fastened to, i.e. screwed onto, the abutment by means of the screw thread. Owing to the thus resulting screw connection, it is no longer necessary to use dental cement, rendering the risks associated therewith irrelevant. Alternatively or additionally, the superstructure can be released from the abutment in simple manner by screwing. This results in less, less frequent or even no damage to the abutment while releasing the superstructure.

The mutual displacement, or play, can be used to at least partially absorb impacts during use of the abutment, for instance when chewing. Absorbing impacts gives the abutment a shock-absorbing character, which makes use of the abutment more pleasant for a user. It is preferred for the mutual displacement to be possible in the main direction—i.e. the vertical direction—of the abutment, which is oriented from the lower part toward the upper part or vice versa. The respective parts thus move toward each other and away from each other.

In order to enhance attachment of the superstructure the holder can be provided with a drilled hole which can partially receive the superstructure. This therefore allows the superstructure to be placed partially into the upper part, enabling a particularly good connection.

The drilled hole is preferably a blind hole. In this way a bottom is provided at the end of the drilled hole, this providing a separation that helps to prevent infections. This is because the bottom of the blind hole prevents contamination from making its way to a position under the drilled hole.

The screw thread is preferably located in the drilled hole.

Providing the screw thread in the drilled hole enables a relatively compact implant to be obtained. At the same time, the superstructure can also take a compact form since it can be provided with a protrusion which is provided with a screw thread.

Alternatively or additionally, the screw thread is internal, in which case a drilled hole is not strictly necessary, but is advantageous. By way of example, the screw thread can run along an inner surface of the drilled hole. This once again enhances the compact construction of the abutment. An alternative can be embodied by providing an upright edge with an internal screw thread.

The present application therefore also provides a dental superstructure, such as a dental prosthesis, which is provided with a protruding pin, wherein an external screw thread is arranged on the pin.

The abutment can comprise biasing means, such as a compression spring, between the lower part and the upper part for the purpose of biasing the lower part and the upper part away from each other.

With the biasing means a shock-absorbing construction is obtained which makes use of the abutment more pleasant. The shock-absorbing action can optionally be increased by also providing an elastic material between the lower part and the upper part, preferably over the whole contact surface of both components, this in addition to the biasing means. This is referred to below.

In another embodiment the lower part has a cavity on the side of the lower part directed toward the upper part in a mutually connected state, wherein the biasing means are preferably received at least partially in the cavity.

The cavity can provide space for at least a part of the upper part on one hand and for the biasing means on the other. The remaining space in the cavity can further be filled with the above stated elastic material for the purpose of strengthening the shock-absorbing function. The elastic material further serves to prevent any empty spaces being left, which could entail a risk of infection.

It is particularly advantageous for the cavity to provide space for the drilled hole of the upper part. In a practical sense, the drilled hole then extends at least partially in the cavity in a mutually connected state of the lower part and the upper part.

In this way a more compact construction is obtained. Sufficient height is particularly provided for a screw thread of sufficient length, so that the abutment as a whole need not take a particularly long form (in the main direction).

In order to provide still more height for the screw thread the biasing means can extend at least partially around the drilled hole.

In this way the screw thread extends at least partially adjacently of the drilled hole (i.e. around it), so that optimal use can be made of the height of the abutment for the purpose of forming a relatively long screw thread.

In an embodiment of the abutment the upper part has an end surface and a peripheral wall, as seen in cross-section, and describes therebetween at least one internal corner, wherein the internal corner is rounded.

Rounding the corner prevents the upper part from becoming damaged while being arranged on the lower part. The upper part particularly has a stepped form, as seen in the cross-section, wherein at least the internal corner close to the free end of the peripheral wall is rounded. Other internal corners can also be rounded.

Such a rounded corner is particularly advantageous when the lower part and the upper part are provided with mutually co-acting form-fitting connecting means extending around the periphery of the respective parts. The connecting means can for instance form an assembly of a hook and an engaging surface. Particularly advantageous is a construction with two hooks disposed in opposite directions, which engage on each other and so form an engaging surface for each other.

In the case of form-fitting connecting means it may in any case be necessary to bring about an elastic deformation during arranging in order to bring the connecting means into mutual engagement. The elastic deformation creates relatively great internal stresses at the position of internal corners, which can be reduced by rounding such corners.

Mutual connection can also be facilitated (further), whether the co-acting connecting means are form-fitting or not, by giving the connecting means different all-around peripheral forms.

It is usual in the prior art to give the connecting means a round peripheral form. In this way the parts are rotation-symmetrical, which makes arranging simple for the user.

It has however been found that with the same (round) peripheral form, the internal stresses can be so great that damage is inflicted on the upper part of the abutment in particular. It has been found by applicant that this can be prevented at least partially by giving the connecting means of the two parts of the abutment, these both running all around the periphery of the respective parts, different peripheral forms. Stresses are hereby distributed around the periphery, and less force is needed overall to connect the parts to each other. This reduces the chance of damage.

This feature can otherwise also be advantageously applied for implants which are not provided with a screw thread, but with for instance a traditional holder for superstructures.

It is noted that, although a plurality of surfaces of the lower part and of the upper part can engage on each other, connecting means are in this application understood to mean precisely those parts that ensure that the mutual connection between the upper part and the lower part is maintained. The connecting means thus lock these two parts in the main direction, also referred to as the vertical direction.

It is particularly advantageous to give the connecting means of one of the lower part and the upper part a round peripheral form, the other one therefore having a different peripheral form here. The connecting means of the lower part preferably have a round peripheral form so that anchoring methods using rotation of the lower part can still be used in simple manner.

The connecting means of the lower part are preferably outward directed hooks.

The connecting means of the upper part are here or alternatively preferably inward directed hooks. In both cases hooks are referred to in plural, although strictly speaking there is just one hook, which extends around the periphery of the whole part. It is of course alternatively possible to place a number of the same connecting means with optionally the same intermediate spaces all around the periphery at a position corresponding with the desired peripheral form.

In an embodiment of the abutment an inner surface of the cavity is provided with an adhesion-enhancing coating.

The adhesion to the elastic material which is arranged in the cavity can be improved using the coating.

The elastic material can for instance be a silicone rubber. The material from which the lower part and/or the second part is manufactured can be titanium or a titanium alloy.

The coating can enhance the adhesion of the silicone rubber to for instance titanium or a titanium alloy.

The adhesion-enhancing coating preferably comprises at least a chemical component with a hydrolyzable motif.

In the context of the application a hydrolyzable motif is understood to be a chemical group or structure susceptible to hydrolysis, this being a chemical reaction wherein compounds are separated as a result of water being added.

The hydrolyzable motif of the adhesion-enhancing coating can for instance be chosen from the list comprising: hydroxy, alkoxy, acyloxy, halogen, amine, amide, ester, ketal, catechol and phosphate; wherein the hydrolyzable motif is preferably alkoxy.

The chemical component as part of the adhesion-enhancing coating is preferably a silane motif with 1 or more hydrolyzable motifs.

Silane motifs can be used for coating of metal oxides, such as for instance titanium oxide. In that case such silane motifs comprise an Si atom as well as 1 or more hydrolyzable groups, whereby the silane motif can form a functional bond to the metal oxide surface and so functionalizes the surface for further bonding with for instance elastic materials such as silicone rubber. Preferred embodiments comprise for instance alkoxy silanes. Silanes with 3 alkoxy groups (i.e. trialkoxysilanes) or 4 alkoxy groups (i.e. tetralkoxysilanes) are ideal starting materials as they have a tendency to spread out over the surface to be coated in the manner of a film and in this way can provide for a maximum adhesion of the elastic material.

Alternative chemical components as part of the adhesion-enhancing coating are for instance catechol or phosphate. These motifs comprise hydrolyzable hydroxy motifs, whereby a strong bond to titanium oxide is likewise achieved.

The chemical component with a hydrolyzable motif can further additionally comprise a polymerizable motif, wherein the polymerizable motif is preferably chosen from the list comprising: (meta)acrylate, vinyl, alkylene, ester, epoxy, isocyanate, maleimide, (acryl)amide, carbonate and urethane.

The coating can for instance be primer G611 obtained from TECHNOVENT at Unit 5, York Park, Bridgend Industrial Estate, UK. This primer comprises a chemical component with hydrolyzable silane motif, more particularly a Tetra(2-methoxyethoxy silane) motif.

In particular embodiment the primer comprises at least 1 percent by weight of the chemical component with hydrolyzable motif, more particularly between 1 and 30 percent by weight, such as between 2 and 15 percent by weight, more particularly between 4 and 10 percent by weight. G611 comprises for instance 5 percent by weight of a chemical component with hydrolyzable (silane) motif. A part of the side of the upper part directed toward the lower part can also be provided with a or the adhesion-enhancing coating. Said part preferably closes together with the cavity an inner space in a connected state of the lower part and the upper part.

The above stated advantages of the coating can hereby be extended to the upper part. An inner space, which is thus formed by the upper part and the lower part together, can further be provided with the coating over its whole surface. An exceptionally good adhesion can thus be obtained.

Finally, it is advantageous for the contact surface of the upper part and of the lower part to be wholly provided with the coating.

The elastic material can thus be arranged over the whole contact surface, which enhances the shock-absorbing properties of the abutment.

The invention also relates to a method for arranging a superstructure on an abutment according to any one of the foregoing claims, comprising of screwing the superstructure onto the abutment.

Screwing the superstructure onto the abutment realizes a particularly strong connection, which is nevertheless releasable in relatively simple manner. In particular, no dental cement is needed, whereby the risks associated therewith can be avoided.

In an embodiment of the method use is made of an abutment with the above described features in any suitable combination.

In some cases the method is solely cosmetic.

The invention also relates to a method for manufacturing at least a component of a dental abutment, preferably an upper and/or lower part of a dental abutment as described above, optionally with a screw thread, wherein for forming connecting means of the component use is made of a production technique having a tolerance of a maximum of 0.05 mm, preferably a maximum of 0.04 mm, most preferably a maximum of 0.03 mm.

In manufacture of dental implants it is usual to produce with a tolerance considerably greater than 0.05 mm. Although this produces workable results per se, since the components fit together sufficiently well and generally remain sufficiently connected, there is still a desire for improvement.

Depending on the desired fit, the tolerance can be defined as a maximum positive or negative deviation from a norm, or as a deviation only one of these two directions.

In some cases problems arise when releasing components of two- or multi-part implants. The relatively great usual tolerances could result in deviations which are so great that the abutment is damaged while the superstructure is removed. In such cases the deviation in the size of the components has the result that local stresses in the abutment become too high, generally around the mutual connection of parts of the abutment.

It has been found by applicant that such problems can be solved when use is made of a production technique with a sufficiently small tolerance in manufacture of (the components of) the abutment.

It is noted here that, because it is precisely during removal of the superstructure that the problem occurs, it was heretofore not expected that an improvement in the production method of the abutment itself would provide a solution, especially not since usual implants were otherwise sufficiently effective per se. The improvements, which therefore become visible only when a superstructure is removed, can therefore be deemed surprising.

The invention also relates to an abutment obtained with the above stated improved method.

The invention also relates to assembly of a dental abutment, preferably as described above, optionally with a screw thread, comprising of:
a) providing components to be connected to each other with an adhesion-enhancing coating; more particularly wherein the adhesion-enhancing coating comprises at least a chemical component with a hydrolyzable motif;
b) arranging elastic material; and
c) mutually connecting the components to be connected to each other, wherein step a) comprises of degassing the component or the components provided with the coating.

Degassing the component or the components reduces or prevents any toxic effects of the coating.

The invention is further elucidated with reference to the figures, wherein:

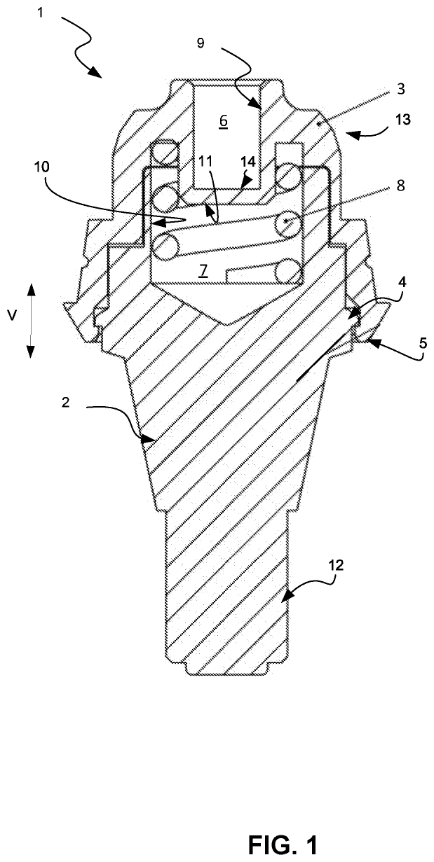

FIG. 1 shows schematically a cross-section of an abutment;

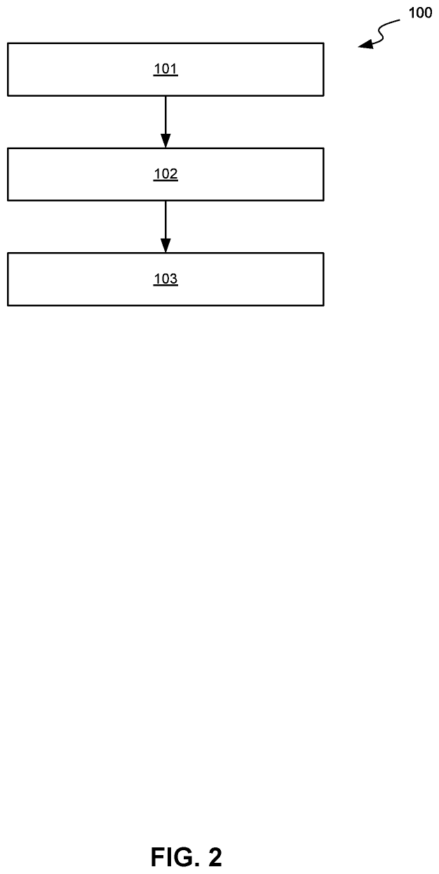

FIG. 2 shows schematically the steps of a method for assembling an abutment; and

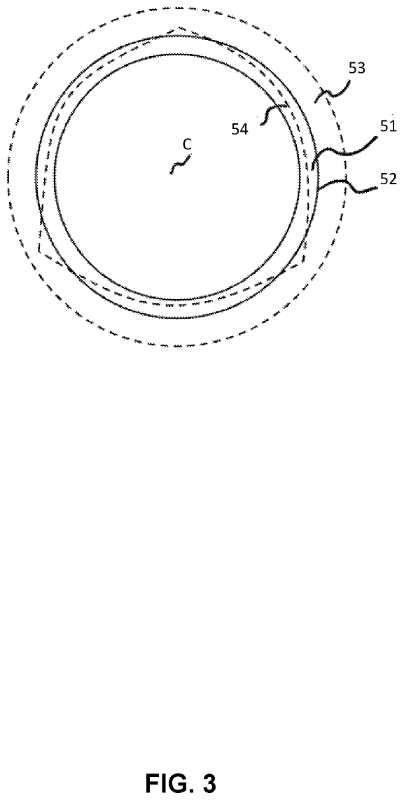

FIG. 3 shows schematically the peripheral form of connecting means of an abutment.

FIG. 1 shows an abutment 1 with a lower part 2 and an upper part 3. An abutment is a connecting element between an implant body already secured in the jaw, for instance through ingrowth and the element replacing the tooth, such as a crown or bridge. The two parts 2, 3 are connected to each other by means of mutually co-acting connecting means 4, 5, these providing a form-fitting locking. In this case the co-acting connecting means 4, 5 are formed by a set of hooks 4, 5 with opposite orientation which engage on each other, although other forms can also be envisaged. The abutment 1 can be placed in a jaw of a person by means of anchor 12. For this application the anchor 12 can be provided with for instance a screw thread, although this is not shown here. Abutment 1 is typically secured to the jaw via an implant which has already been fitted in the jaw. The upper part 3 has a holder 13, in this case formed by the upper surface of upper part 3, i.e. the surface directed away from lower part 2. Holder 13 is used for fastening a superstructure, such as a dental prosthesis, thereon.

The mutual connection between lower part 2 and upper part 3 allows for some play, whereby the parts 2, 3 are displaceable relative to each other in a vertical direction V, i.e. toward each other and away from each other. The vertical direction V corresponds with the main direction of abutment 1. This movement enables shocks to be absorbed, particularly in combination with biasing means 8 which urge the two parts 2, 3 apart. A compression spring 8 is provided in this case, although a different type of biasing means is possible. In any case, the biasing means 8 provide for the two components 2, 3 being biased away from each other, together with an elastic material which will be discussed further below. Biasing means 8 are arranged in a cavity 7 in lower part 2 intended for this purpose and, from there, extend upward toward upper part 3. When it is connected to lower part 2, upper part 3 lies against the biasing means 8. At the same time, upper part 3 closes the cavity 7 here with a part 11 of its underside which is directed toward lower part 2. An enclosed inner space is thus created by cavity 7 and this part 11 of the underside. The enclosed inner space is filled with, in addition to biasing means 8, an elastic material (not shown here), which serves on one hand to absorb forces and on the other hand ensures that no hollow spaces remain. In order to guarantee good adhesion between the material on one hand and the two parts 2, 3 on the other an adhesion-enhancing coating is provided over the whole inner surface of the inner space, which is formed by an inner surface 10 of cavity 7 and the part 11 of upper part 3 closing the cavity 7. The coating is also applied to the rest of the contact surface of lower part 2 and upper part 3. The elastic material is arranged over the whole contact surface.

The upper side of upper part 3, i.e. the side directed away from lower part 2, is provided with a drilled hole 6, in this case a blind hole. The drilled hole 6 therefore has a bottom 14. Drilled hole 6 is provided along the inner wall with an internal screw thread 9. A superstructure (not shown) can be secured onto screw thread 9 by screwing, so that drilled hole 6 and the screw thread form part of the holder 13 of upper part 3.

FIG. 2 shows schematically the three steps 101, 102, 103 of a method 100 for assembling a dental abutment. In a first step 101 components to be connected to each other are provided with an adhesion-enhancing coating. The coating is for instance provided on the whole contact surface of one or both components. Following application of a coating the components are degassed. In a second step 102 elastic material is arranged, for instance on one or both of the components, particularly over the whole contact surface thereof. Finally, the components are connected to each other in a third step 103.

FIG. 3 finally shows highly schematically the peripheral forms of the connecting means 4, 5 of an upper part 3 and of a lower part 2 of an abutment. The peripheral form 51 of lower part 2 is round, and is in this case formed by outward-directed (i.e. radially outward from a centre C) hooks 4 (see FIG. 1). The outer surface 52 of the hooks forms the surface around which the upper part 3 must be placed so as to be connected to lower part 2. Upper part 3 has for this purpose hooks 5 (see FIG. 1) in the opposite direction, i.e. directed radially toward the centre C (i.e. inward). The hooks 5 of upper part 3 have here a peripheral form 53 which is not round, at least not on the inner side 54 thereof. Because the inner side 54 of the hooks 5 of upper part 3 must be placed over the outer side 52 of the hooks 4 of lower part 2 for the purpose of connecting lower part 2 and upper part 3, both hooks must deform to some extent and temporarily, at least where inner surface 54 of the one part lies inside the outer surface 52 of the other. The non-round form of inner surface 54 relative to the round form of outer surface 52 enhances mutual connection and reduces the risk of damage.

Although the invention is described above on the basis of a limited number of examples and embodiments, it is not limited thereto. On the contrary, the invention is also defined by the appended claims.

1. A dental abutment for holding a superstructure, such as a dental prosthesis, comprising a lower part and an upper part, which are mutually connected and are displaceable relative to each other in a direction away from each other and toward each other, wherein the lower part comprises an anchor for anchoring the abutment in the jaw and wherein the lower part comprises a cavity on the side of the lower part directed toward the upper part, and wherein the upper part comprises a holder for fastening the superstructure thereon, wherein the holder has a screw thread,
wherein
an inner surface of the cavity is provided with an adhesion-enhancing coating, wherein the adhesion-enhancing coating comprises at least a chemical component with a hydrolyzable motif.

2. The dental abutment according to claim 1, wherein the holder comprises a drilled hole for partially receiving the superstructure.

3. The dental abutment according to claim 2, wherein the drilled hole is a blind hole.

4. The dental abutment according to claim 2, wherein the screw thread is located in the drilled hole and/or wherein the screw thread is internal.

5. The dental abutment according to claim 1, further comprising biasing means, such as a compression spring, placed between the lower part and the upper part for the purpose of biasing the lower part and the upper part away from each other.

6. The dental abutment according to claim 2, wherein the biasing means are received at least partially in the cavity.

7. The dental abutment according to claim 6, wherein the drilled hole extends at least partially in the cavity.

8. The dental abutment according to claim 7, wherein the biasing means extend at least partially around the drilled hole.

9. The dental abutment according to claim 1, wherein the upper part comprises an end surface and a peripheral wall, as seen in cross-section, and describes therebetween at least one internal corner, wherein the internal corner is rounded.

10. The dental abutment according to claim 1, wherein the lower part and the upper part are provided with mutually co-acting connecting means extending around the periphery of the respective parts, wherein the connecting means of the respective lower part and upper part have different peripheral forms.

11. The dental abutment according to claim 1, wherein a peripheral form of one of the connecting means of the respective lower part or upper part is round, and the peripheral form of the other connecting means is not round.

12. The dental abutment according to claim 1, wherein the hydrolyzable motif is chosen from the list comprising: hydroxy, alkoxy, acyloxy, halogen, amine, amide, ester, ketal, catechol and phosphate; wherein the hydrolyzable motif is preferably alkoxy.

13. The dental abutment according to claim 1, wherein the chemical component with a hydrolyzable motif is a silane motif with 1 or more hydrolyzable motifs according to claim 12.

14. The dental abutment according to claim 1, wherein the chemical component with a hydrolyzable motif further comprises a polymerizable motif, wherein the polymerizable motif is preferably chosen from the list comprising (meta)acrylate, vinyl, alkylene, ester, epoxy, isocyanate, maleimide, (acryl)amide, carbonate and urethane.

15. The dental abutment according to claim 1, wherein at least a part of the side of the upper part directed toward the lower part is provided with an adhesion-enhancing coating, wherein said part closes together with the cavity an inner space.

16. The dental abutment according to claim 1, wherein a contact surface of the upper part and of the lower part is wholly provided with an adhesion-enhancing coating.

17. The dental abutment according to claim 5, wherein the biasing means are provided with an adhesion-enhancing coating.

18. A method for arranging a superstructure on an abutment according to claim 1, comprising of screwing the superstructure onto the abutment.

19. A method for manufacturing at least a component of a dental abutment according to claim 1,
wherein
for forming connecting means of the component use is made of a production technique having a tolerance of a maximum of 0.05 mm, preferably a maximum of 0.04 mm, most preferably a maximum of 0.03 mm.

20. (canceled)

21. A method for assembling a dental abutment, according to claim 1, the method comprising:
a) providing components to be connected to each other with an adhesion-enhancing coating, wherein the adhesion-enhancing coating comprises at least a chemical component with a hydrolyzable motif;
b) arranging an elastic material; and
c) mutually connecting the components to be connected to each other,
wherein step a) comprises of degassing the component or the components provided with the coating.
